(19) United States
(12) Patent Application Publication
(10) Pub. No.: US 2025/0128228 A1
(43) Pub. Date: Apr. 24, 2025

(54) ORGANIC ALUMINUM SOL AND PREPARATION METHOD THEREOF

(71) Applicant: Xiamen University, Xiamen (CN)

(72) Inventors: Siwei Li, Xiamen (CN); Ying Liang, Quanzhou City (CN); Li Zhang, Foshan (CN)

(21) Appl. No.: 18/919,829

(22) Filed: Oct. 18, 2024

(30) Foreign Application Priority Data
Oct. 24, 2023 (CN) 202311379160.7

(51) Int. Cl. B01J 13/00; B05D 1/00

(52) U.S. Cl. CPC B01J 13/003; B01J 13/0039; B01J 13/0043; B05D 1/005

(57) ABSTRACT

An organic aluminum sol and a preparation method thereof related to chemical technology fields. Organic mixed acids are used to react with aluminum powder to prepare organic aluminum sol as a precursor for preparing alumina fiber. The aluminum powder, formic acid, and oxalic acid are used as raw materials, the oxalic acid and the formic acid are firstly mixed to be even according to a preset ratio to obtain a mixed acid solution, and the aluminum powder is then completely reacted with the mixed acid solution to obtain an aluminum carboxylate solution under a condensation reflux condition, and the aluminum carboxylate solution is finally filtered to obtain the aluminum carboxylate sol that is clear and transparent. A chemical formula of a composition of the organic aluminum sol is expressed as: Al(OH)ₓ(HCOO)_{y}(COO—COO)_{z}, wherein 0<x<2, 0<y<2, and 0<z<1.

### RELATED APPLICATIONS

This application claims priority to Chinese patent application number 202311379160.7, filed on Oct. 24, 2023. Chinese patent application number 202311379160.7 is incorporated herein by reference.

### FIELD OF THE DISCLOSURE

The present disclosure relates to the field of chemical technologies, and in particular relates to an organic aluminum sol and a preparation method thereof.

### BACKGROUND OF THE DISCLOSURE

Alumina is the most important oxide ceramic. Ceramic products of different dimensions, such as nano-scale powder, nano-scale wires, fibers, films, and aerogel blocks, can be prepared by a sol-gel method. Alumina and a precursor thereof (e.g., boehmite or aluminum hydroxide) can be dispersed in a solvent by a peptization method or a grinding dispersion method. The resulting colloid usually has a low viscosity and is not suitable as a raw material for fibers and films. In order to prepare alumina fibers or alumina films, an alumina sol with a preset viscosity is required. Alumina sols that meet viscosity requirements are usually synthesized by two technical routes of a hydrolysis method of alcoholates and polyaluminum chloride. In the hydrolysis method of the alcoholates, organic aluminum alcoholates, such as aluminum isopropoxide and/or aluminum sec-butoxide, are used as aluminum sources, hydrolyzed, and polycondensed in organic solvents to obtain the alumina sols that meet the viscosity requirements. In a technical solution, metallic aluminum, hydrochloric acid, aluminum trichloride, and the like are reacted to obtain the polyaluminum chloride sols that meet the viscosity requirements. A preparation process of an aluminum solution prepared by a sol-gel method using aluminum alkoxides and/or aluminum alkyls as raw materials is complex and high cost, and a recovery of organic solvents is also involved. A sol of the polyaluminum chloride contains a large amount of chloride ions, and highly corrosive hydrochloric acids will be formed during subsequent calcination and decomposition processes, causing a great pollution to the environment and being prone to damage of heat treatment equipment. Therefore, it is very important to seek a low-cost and pollution-free method for preparing aluminum sol.

### BRIEF SUMMARY OF THE DISCLOSURE

An objective of the present disclosure is to provide an organic aluminum sol to reduce environmental pollution in view of the deficiencies of the existing alumina sol.

Another objective of the present disclosure is to provide a preparation method of the organic aluminum sol having a low cost.

An organic aluminum sol, a solute of the organic aluminum sol comprises Al(OH)ₓ(HCOO)_{y}(COO—COO)_{z}, wherein 0<x<2, 0<y<2, and 0<z<1.

In a preferred embodiment, the solute of the organic aluminum sol is Al(OH)ₓ(HCOO)_{y}(COO—COO)_{z}.

In a preferred embodiment, a gel obtained by dehydration of the organic aluminum sol is amorphous.

A preparation method of the organic aluminum sol, the method comprises:
step 1) dissolving oxalic acid in water to prepare an oxalic acid solution;
step 2) adding formic acid to the oxalic acid solution and mixing to be even to obtain a mixed acid solution;
step 3) adding aluminum powder to the mixed acid solution and heating for reaction; and
step 4) filtering to obtain a transparent and clear organic aluminum sol after the aluminum powder is dissolved.

In a preferred embodiment, a molar ratio of the oxalic acid, the formic acid, and the aluminum powder is (0.3-1.2):(0.5-3):1.

In a preferred embodiment, in the step 3, a weight ratio of the aluminum powder to the mixed acid solution is 4-10:100.

In a preferred embodiment, in the step 3, a temperature of the reaction is 80-120° C., and a time of the reaction is 4-12 hours.

A method for preparing an alumina fiber, an alumina film, an alumina coating, or an alumina bulk using the organic aluminum sol as a raw material. The organic aluminum sol can be used in fields of metals, casting, ceramics, chemicals, furnaces, etc.

Compared with the existing techniques, the present disclosure has the following advantages and beneficial effects.

1) Raw materials of the organic aluminum sol are simple and easily obtained. Metal aluminum, the formic acid, and the oxalic acid are used as raw materials. Compared with an organic aluminum sol prepared by a sol-gel method using aluminum alkoxides and/or aluminum alkyls as raw materials, a cost of the organic aluminum sol in the present disclosure is low, no toxic and harmful substances are produced, and synthesis can be performed at a large scale. Condensation reflux is used as a synthesis condition without an external catalyst, and an operation of a preparation process is simple, safe, and controllable. Corrosion for high-temperature equipment due to chloride ions can be avoided.

2) The organic aluminum sol prepared by the present disclosure has a uniform and transparent appearance, stable properties, and no coagulation occurs after a long-term placement. After the organic aluminum sol is dried to be converted into gel, the gel is amorphous and has high activity.

3) The organic aluminum sol of the present disclosure has increased viscosity after concentration, is spinnable, and is suitable as a precursor for alumina films and alumina fibers.

### BRIEF DESCRIPTION OF THE DRAWINGS

FIG. 1 is a flow chart of a process of a preparation method of an organic aluminum sol of the present disclosure.

FIG. 2 is an X-Ray Diffraction (XRD) spectrum of an organic aluminum sol in Embodiment 2 after the organic aluminum sol is converted into a gel.

FIG. 3 is an infrared spectrum of the organic aluminum sol in Embodiment 2 after the organic aluminum sol is converted into a gel.

FIGS. 4A and 4B are scanning electron microscope (SEM) photographs of an as-prepared gel fiber in Embodiment 7.

FIG. 5 is an optical microscope (OM) photograph of an as-prepared gel film in Embodiment 8.

FIG. 6 is an infrared spectrum of aluminum oxalate in Comparative Embodiment 1.

FIG. 7 is an XRD spectrum of a white precipitate in Comparative Embodiment 2.

FIG. 8 is an infrared spectrum of the white precipitate in Comparative Embodiment 2.

FIG. 9 shows that a reaction of aluminum powder is incomplete when an original concentration of a mixed acid is too high in Comparative Embodiment 3.

FIG. 10 is a photo of an organic aluminum sol in Embodiment 9.

FIG. 11 is an XRD spectrum of the organic aluminum sol in Embodiment 9 after the organic aluminum sol is dried to obtain a gel.

FIG. 12 is an infrared spectrum of the organic aluminum sol in Embodiment 9 after the organic aluminum sol is dried to obtain the gel.

### DETAILED DESCRIPTION OF THE EMBODIMENTS

In order to well illustrate the objective, the technical solution, and the advantages of the present disclosure, the present disclosure will be further described in combination with the following embodiments. It is obvious that the embodiments are some embodiments of the present disclosure instead of all embodiments. It should be understood that the embodiments of the present disclosure are merely used to illustrate the technical effects of the present disclosure rather than to limit a protective scope of the present disclosure.

### Embodiment 1

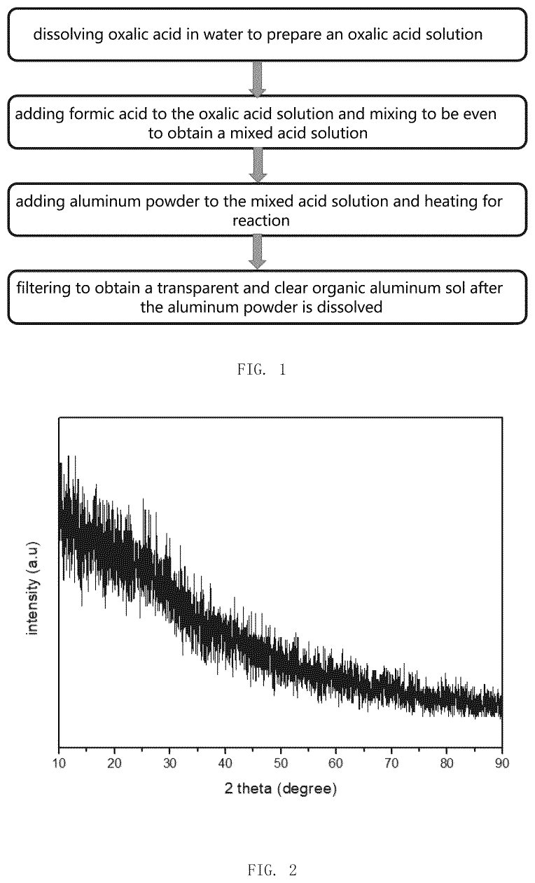

An organic aluminum sol is provided, and a chemical formula of a composition of the organic aluminum sol is expressed as follows: Al(OH)ₓ(HCOO)_{y}(COO—COO)_{z}, wherein 0<x<2, 0<y<², and 0<z<1. After the organic aluminum sol is concentrated and dehydrated to obtain a gel, the gel is found to be amorphous using an X-Ray Diffraction (XRD) test. The preparation method of the organic aluminum sol of the present disclosure is shown in FIG. 1, and the preparation method comprises the following steps:
Step 1) oxalic acid is dissolved in water to prepare an oxalic acid solution;
Step 2) formic acid is added to the oxalic acid solution and mixed to be even to obtain a mixed acid solution;
Step 3) aluminum powder is added to the mixed acid solution and heated for reaction to obtain a reaction solution; and
Step 4) the reaction solution is filtered to obtain the organic aluminum sol that is transparent and clear after the aluminum powder is dissolved.

A molar ratio of the oxalic acid, the formic acid, and the aluminum powder is (0.3-1.2):(0.5-3):1, a weight ratio of the aluminum powder and the mixed acid solution is 4-10:100, a temperature for the reaction is 80-120° C., and a time for the reaction is 4-12 hours.

Organic mixed acids are used to react with the aluminum powder to prepare the organic aluminum sol as a precursor for preparing alumina fiber, etc. The aluminum powder, the formic acid, and the oxalic acid are used as raw materials, the oxalic acid and the formic acid are firstly mixed to be even according to a preset ratio to obtain a mixed acid solution, and the aluminum powder is then completely reacted with the mixed acid solution to obtain an aluminum carboxylate solution, and the aluminum carboxylate solution is finally filtered to obtain the aluminum carboxylate sol that is clear and transparent.

### Embodiment 2

A preparation method of an organic aluminum sol comprises the following steps.
Step 1) 100.2 g of oxalic acid dihydrate is dissolved in 300 g of deionized water to prepare an oxalic acid solution;
Step 2) 101.2 g of formic acid is added to the oxalic acid solution and mixed to be even to obtain a mixed acid solution;
Step 3) 27 g of aluminum powder is added to the mixed acid solution and refluxed for 10 hours by heating to 95° C. in a water bath to obtain a reaction solution; and
Step 4) the reaction solution is filtered to obtain the organic aluminum sol that is transparent and clear after the aluminum powder is dissolved.

After the organic aluminum sol is concentrated and dehydrated at 60° C. to obtain a gel, the gel is a transparent and light yellow solid and is found to be amorphous through an X-Ray Diffraction (XRD) test using a powder compression method, as shown in FIG. 2. An infrared spectrum of the gel is shown in FIG. 3. FIG. 3 contains characteristic vibrational peaks of oxalate, formate, and hydroxyl, indicating that the organic aluminum sol contains hydroxyl groups.

Organic mixed acids are used to react with the aluminum powder to prepare organic aluminum sol as a precursor for preparing alumina fiber, etc. The aluminum powder, formic acid, and oxalic acid are used as raw materials, the oxalic acid and the formic acid are firstly mixed to be even according to a preset ratio to obtain a mixed acid solution, and the aluminum powder is then completely reacted with the mixed acid solution to obtain an aluminum carboxylate solution under a condensation reflux condition, and the aluminum carboxylate solution is finally filtered to obtain the aluminum carboxylate sol that is clear and transparent.

### Embodiments 3-6

Preparation methods of organic aluminum sols in Embodiments 3-6 are similar to the preparation method of the organic aluminum sol in Embodiment 2, and corresponding ratios of raw materials and corresponding reaction conditions are shown in Table 1.

TABLE 1
Synthesis conditions of the organic aluminum sols in Embodiments 3-6

| Embod- | Aluminum/ | Oxalic Acid | Formic | Deionized | Reaction | Crystalline |
|---|---|---|---|---|---|---|
| iment | g | dihydrate/g | Acid/g | Water/g | Condition | phase |
| 3 | 10.8 | 50.4 | 27.6 | 115 | 80° C./12 hours | amorphous |
| 4 | 20.25 | 56.7 | 82.8 | 200 | 90° C./8 hours | amorphous |
| 5 | 13.5 | 25.2 | 64.4 | 50 | 100° C./10 hours | amorphous |
| 6 | 16.2 | 90.72 | 18.4 | 150 | 110° C./4 hours | amorphous |

For example, in Embodiment 3, a clear sol can be obtained by ensuring a sufficiently large concentration of the mixed carboxylic acids without an addition of a catalyst, and the reaction is relatively smooth and easy to control without post-treatment of the added catalyst.

### Embodiment 7

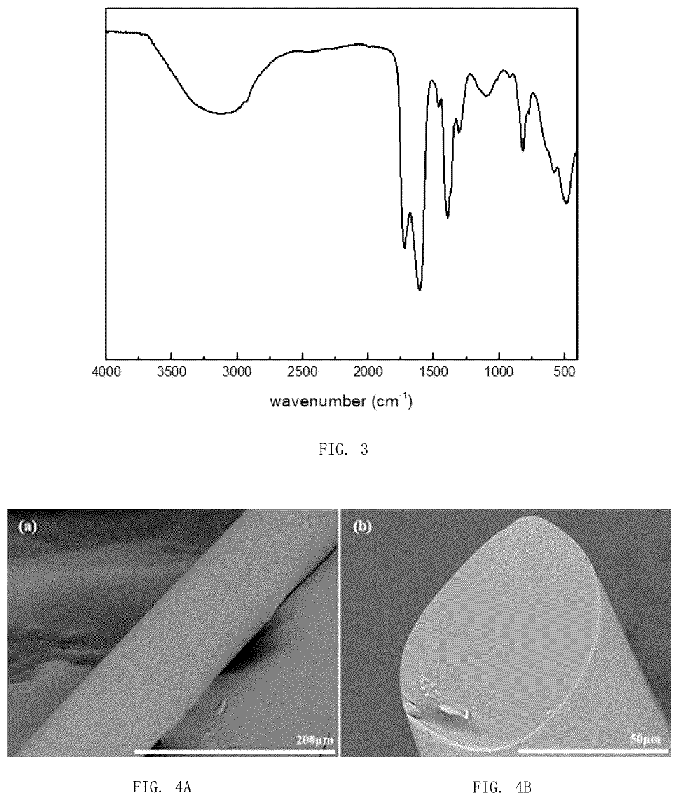

100 g of the organic aluminum sol synthesized in Embodiment 4 is concentrated under a reduced pressure (e.g., <1 atm) by evaporation at 60° C., and a viscous and yellow sol with a mass of 54 g is obtained. The viscosity of the organic aluminum sol is 1490 mPa·s. A glass rod is inserted into the organic aluminum sol and pulled upward, and gel fibers with lengths of 30-60 cm are pulled out. The scanning electron microscope (SEM) photographs of the as-prepared gel fibers are shown in FIGS. 4A and 4B. The gel fibers are transferred to a corundum crucible, dried in an oven at 60° C. for 24 hours, then heated (i.e., calcined) in a muffle furnace at 1100° C. for 30 minutes, and alumina fibers are finally obtained. Therefore, the organic aluminum sol synthesized by the present disclosure can be used as a raw material of a precursor for preparing the alumina fibers or fibers containing alumina.

### Embodiment 8

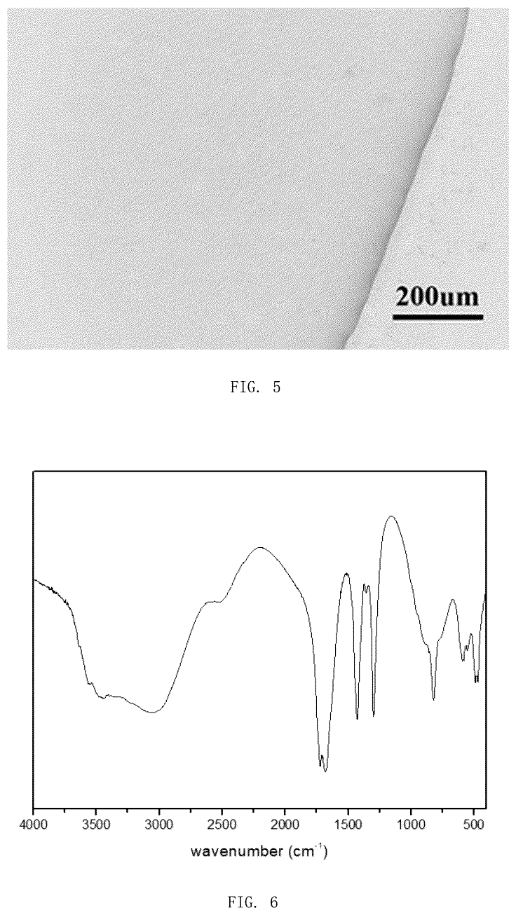

Preparation of precursor dope: 80 g of organic aluminum sol synthesized in Embodiment 5 is used as a raw material, and 10 g of a polyvinyl alcohol solution with a concentration of 10 wt % is added in the organic aluminum sol while electromagnetic stirring at a speed of 300 revolutions per minute for 4 hours. A uniform gel film on a glass plate is obtained by spin coating of the precursor dope. The optical microscope (OM) photograph (e.g., 50× magnification) of the as-prepared uniform gel film is shown in FIG. 5. The as-prepared uniform gel film is carefully transferred to a corundum crucible, dried in an oven at 60° C. for 24 hours, then heated in a muffle furnace at 900° C. for 30 minutes, and an alumina film is finally obtained. Therefore, the organic aluminum sol synthesized by the present disclosure can be used as a raw material for the alumina film or an alumina coating.

### Embodiment 9

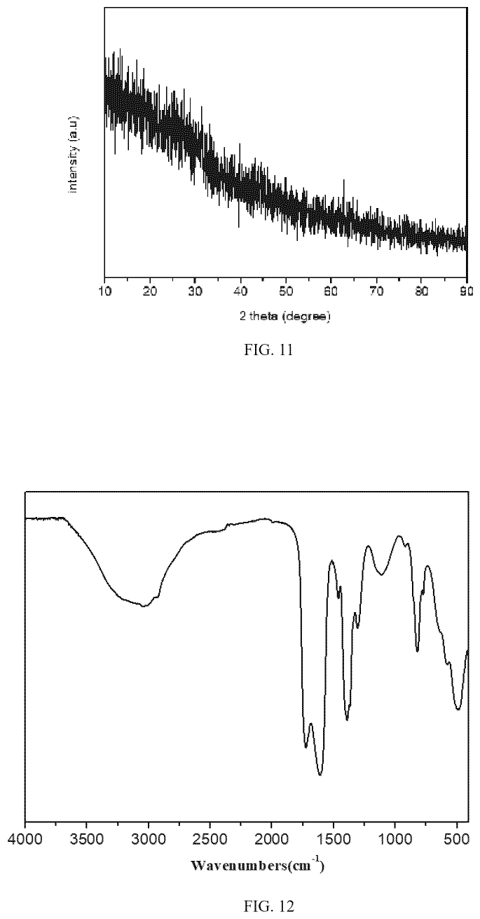

After the organic aluminum sol synthesized in Embodiment 2 is maintained at room temperature (e.g., 20-25° C.) for 1 year, the organic aluminum sol is still clear and transparent, as shown in FIG. 10. The organic aluminum sol is concentrated and dehydrated at 60° C. to obtain a gel, and the gel is a transparent yellowish solid. The gel is ground into powder and measured by an X-Ray Diffraction (XRD) method, and an XRD spectrum that is obtained is shown in FIG. 11. As illustrated in FIG. 11, the organic aluminum sol remains amorphous and does not undergo crystallization. The infrared spectrum of the powder of the gel is shown in FIG. 12, which is almost identical to the infrared spectrum of the sample of Embodiment 2. The organic aluminum sol synthesized by the present disclosure has properties of being very stable, and the organic aluminum sol does not gelate or crystallize during storage.

### Comparative Embodiment 1

189 g of oxalic acid dihydrate is dissolved in 265 g of deionized water to prepare an oxalic acid solution, and 27 g of aluminum powder is then added and refluxed for 12 hours for reaction by heating to 95° C. in a water bath. The aluminum powder is dissolved and filtered to obtain a transparent and clear liquid, that is, an aluminum oxalate solution. The transparent and clear liquid is concentrated and dehydrated at 60° C., which always remains in a liquid state (e.g., a sticky liquid state) instead of converting into a gel. Therefore, a small-molecule aluminum oxalate is synthesized, while an organic aluminum sol configured to be converted into the gel is not synthesized. The infrared spectrum of the aluminum oxalate solution is shown in FIG. 6, which is significantly different from the infrared spectrum of the organic aluminum sol in Embodiments 1-6 and 9 (e.g., the organic aluminum sol in Embodiment 2).

### Comparative Embodiment 2

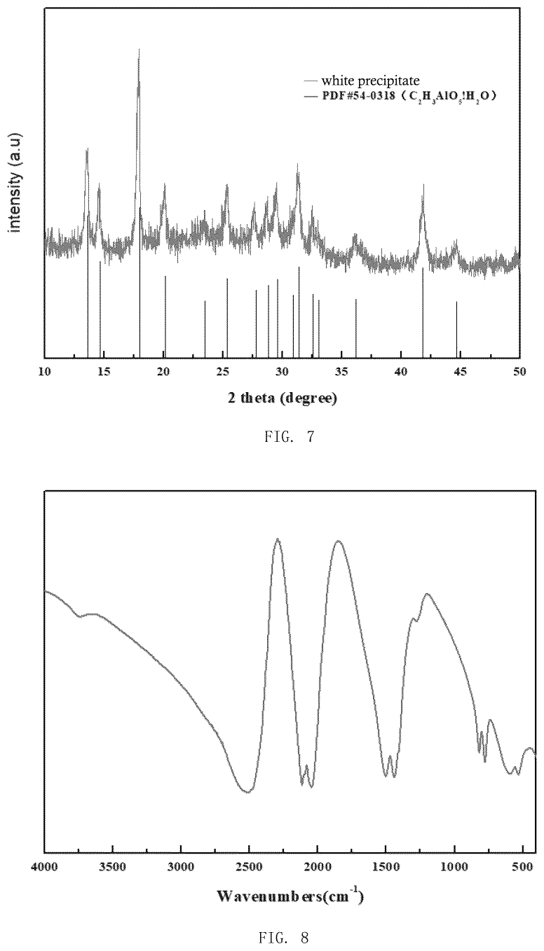

148 g of formic acid is dissolved in 265 g of deionized water to prepare a formic acid solution, 27 g of aluminum powder is then added and refluxed by heating to 95° C. for 12 hours for reaction in a water bath. Part of the aluminum powder is dissolved to obtain a white precipitate. The white precipitate is centrifuged, washed, and dried, and an X-Ray Diffraction (XRD) spectrum of the white precipitate is tested using a powder compression method, as shown in FIG. 7. Therefore, the white precipitate is crystals, and diffraction peaks of the white precipitate well match with a standard card (PDF #54-0318) of aluminum formate (C₂H₃AlO₅·H₂O). Therefore, crystals of the aluminum formate are synthesized instead of an amorphous sol. An infrared spectrum of the white precipitate is shown in FIG. 8, and the infrared spectrum of the white precipitate is also obviously and significantly different from an infrared spectrum of the organic aluminum sol in Embodiment 2.

### Comparative Embodiment 3

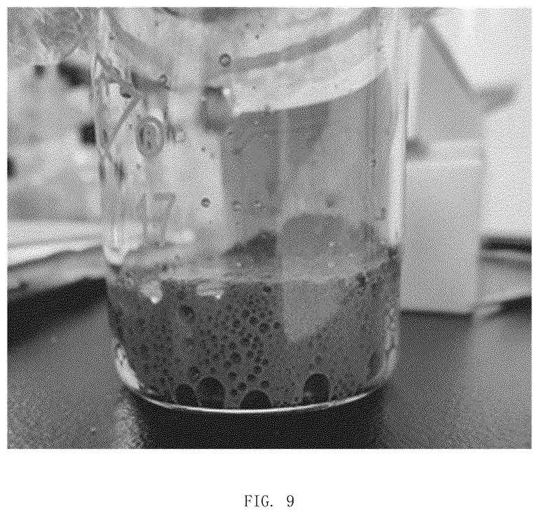

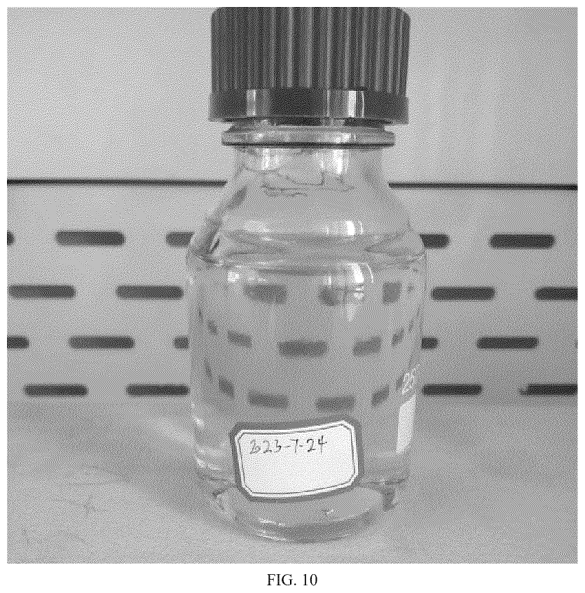

56.7 g of oxalic acid is added into 60 g of deionized water, heated to 50° C., and dissolved to obtain an oxalic acid solution, and 82.8 g of formic acid and 27 g of aluminum powder are then added and refluxed for 8 hours by heating to 90° C. in a water bath. Merely part of the aluminum powder is dissolved to form a very viscous colloid. After cooling to room temperature (e.g., 20-25° C.), the viscosity of the very viscous colloid is found to exceed 100,000 mPa·s by a measurement using a rotational viscometer. Therefore, when too much of the aluminum powder is added, the reaction of the aluminum powder will be incomplete, so that the organic aluminum sol is not clear, as shown in FIG. 9.

In summary, the present disclosure provides an organic aluminum sol and a preparation method thereof. The transparent and clear aluminum sol can be obtained under a suitable ratio of organic mixed acids, and the transparent and clear aluminum sol can be used as a raw material of a precursor for materials, such as alumina film and alumina fiber.

### Comparative Embodiments 4 and 5

A preparation process of an organic aluminum sol in Comparative Embodiments 4 and 5 is similar to Embodiment 3, and corresponding raw material ratios and reaction conditions are shown in Table 2.

TABLE 2
Synthesis conditions of the organic aluminum sols in Comparative
Embodiments 4 and 5

| Compar- | | oxalic | | | | | | |
|---|---|---|---|---|---|---|---|---|
| ative | Aluminum | acid | formic | deionized | | | | |
| Embod- | powder/ | dihydrate/ | acid/ | water/ | | | Reaction | Sol |
| iments | g | g | g | g | catalyst | catalyst/g | conditions | appearance |
| 4 | 10.8 | 50.4 | 27.6 | 250 | No | No | 80°.C/ | Semi- |
| | | | | | | | 12 | transparent |
| | | | | | | | hours | |
| 5 | 10.8 | 50.4 | 27.6 | 250 | 36% | 2 | 80° C./ | Clear |
| | | | | | HCl | | 12 | and |
| | | | | | solution | | hours | transparent |

In Comparative Embodiment 4, 50.4 g of the oxalic acid dihydrate is added into 250 g of the deionized water and heated to 50° C. to be dissolved to obtain an oxalic acid solution. 27.6 g of the formic acid and 10.8 g of the aluminum powder are then added and refluxed for reaction for 12 hours by heating to 80° C. in a water bath to obtain a semi-transparent turbid colloid. An original concentration of an acid mixture is too small and not acidic enough for the aluminum powder to react to obtain a clarified sol.

In Comparative Embodiment 5, 50.4 g of the oxalic acid dihydrate is added into 250 g of the deionized water and heated to 50° C. to be dissolved to obtain an oxalic acid solution. 2 g of a hydrochloric acid solution (36 wt %) as a catalyst, 27.6 g of the formic acid, and 10.8 g of the aluminum powder are then added and refluxed for reaction for 12 hours by heating to 80° C. in a water bath to obtain a clear and transparent sol. In Comparative Embodiment 5, after hydrochloric acid is added as a strong acid, an original acidity of the acid mixture is increased, and a clear sol can be obtained. However, an addition of the catalyst introduces chloride ions into the organic aluminum sol. Reaction equipment, such as metal components, is prone to corrode. Moreover, chloride will escape during calcination and pyrolysis of subsequent products, such as gel fibers and gel films, to generate an acid gas of HCl, causing corrosion of heat treatment equipment, such as a furnace.

It should be finally noted that the aforementioned embodiments are merely used to explain the technical solution of the present disclosure instead of a limitation of the protection scope of the present disclosure. Although the present disclosure is described in detail in view of the preferred embodiments, it should be understood by a person of ordinary technical skill in the art that modifications or equivalent substitutions of the technical solution of the present disclosure can be made without departing from the substance and scope of the technical solution of the present disclosure.

What is claimed is:

1. An organic aluminum sol, wherein a solute of the organic aluminum sol comprises Al(OH)ₓ(HCOO)_{y}(COO—COO)_{z}, wherein 0<x<2, 0<y<2, and 0<z<1.

2. The organic aluminum sol according to claim 1, wherein the solute of the organic aluminum sol is Al(OH)ₓ(HCOO)_{y}(COO—COO)_{z}.

3. The organic aluminum sol according to claim 1, wherein a gel obtained by dehydration of the organic aluminum sol is amorphous.

4. A preparation method of the organic aluminum sol according to claim 1, comprising:
step 1) dissolving oxalic acid in water to prepare an oxalic acid solution;
step 2) adding formic acid to the oxalic acid solution and mixing to be even to obtain a mixed acid solution;
step 3) adding aluminum powder to the mixed acid solution and heating for reaction; and
step 4) filtering to obtain a transparent and clear organic aluminum sol after the aluminum powder is dissolved.

5. The preparation method according to claim 4, wherein a molar ratio of the oxalic acid, the formic acid, and the aluminum powder is (0.3-1.2):(0.5-3):1.

6. The preparation method according to claim 4, wherein in the step 3, a weight ratio of the aluminum powder to the mixed acid solution is 4-10:100.

7. The preparation method according to claim 4, wherein in the step 3, a temperature of the reaction is 80-120° C., and a time of the reaction is 4-12 hours.

8. A method for preparing an alumina fiber using the organic aluminum sol according to claim 1 as a raw material, comprising:
adding the organic aluminum sol,
concentrating the organic aluminum sol to obtain concentrated organic aluminum sol, and
pulling out the concentrated organic aluminum sol, drying, and calcining to obtain the alumina fiber.

9. A method for preparing an alumina film or an alumina coating using the organic aluminum sol according to claim 1 as a raw material, comprising:
adding the organic aluminum sol,
adding a polyvinyl alcohol solution to the organic aluminum sol while stirring to obtain a precursor dope, and
forming the precursor dope by spin coating to obtain the alumina film or the alumina coating.

10. A method for preparing an alumina bulk using the organic aluminum sol according to claim 1 as a raw material, comprising:
concentrating the organic aluminum sol to obtain concentrated organic aluminum sol, and
forming the concentrated organic aluminum sol to obtain the alumina bulk.
